(19) United States
(12) Patent Application Publication
(10) Pub. No.: US 2010/0021181 A1
(43) Pub. Date: Jan. 28, 2010

(54) Device, System, and Method of Communication Using Path State Modulation

(76) Inventors: Sy Foguel, New York, NY (US); Dekel Shiloh, New York, NY (US)

Correspondence Address: Shiloh et al., 99 John St., Suite 2303, New York, NY, 10038, US

(21) Appl. No.: 12/507,097

(22) Filed: Jul. 22, 2009

Related U.S. Application Data
(63) Continuation of application No. 11/147,272, filed on Jun. 8, 2005, now abandoned.
(60) Provisional application No. 60/577,582, filed on Jun. 8, 2004.

(51) Int. Cl. H04B 10/30; H04B 10/04

(52) U.S. Cl. 398/183

(57) ABSTRACT

A communication method including: modulating one more information data bits at a first site by selectively switching the path state of a first stream of photons, and demodulating said information data bits at a second site by detecting appearance and disappearance of an interference pattern of a second stream of photons correlated with said first stream of photons.

### FIELD OF THE INVENTION

The present invention relates to quantum theory and to devices, systems and methods of communication.

### BACKGROUND OF THE INVENTION

Conventional wisdom dictates that information, e.g., data, must be carried by a substantive medium, i.e., mass and/or energy, in order to be transmitted across a macroscopic distance. The fastest known communication methods involve modulating a physical property, e.g., the frequency, amplitude or phase, of a coherent beam of light with information data at a first location (“information origin”), transmitting the light beam to a second location (“information destination”) along a predetermined macroscopic path, and demodulating the modulated light beam at the second location to extract the information data.

The time of transmission of conventional communication systems depends on the macroscopic distance between the first and second locations, and may be calculated by dividing the distance by the speed of the carrier, e.g., the speed of light. For example, if the distance between the origin and destination of the information is one light year, then the minimum transmission latency is one year, by definition.

According to quantum theory, the position of a fast moving particle, e.g., a photon or an electron, may not be determined with certainty. This uncertainty is inherent and may depend on events that occur along the path of the particle. For example, when a photon encounters a symmetric beam splitter, there is a probability of 50% that the photon will continue its travel along a first path and an equal probability of 50% that the photon will continue its travel along a second, different and distinct path. This election is completely random. Furthermore, and more interestingly, these probabilities remain in place even after the splitting event, i.e., there is no way of determining the path taken by the photon without empirically detecting the actual photon along either the first or second path. Moreover, without empirical detection of the photon, there is inherent uncertainty in the actual photon path; i.e., not only is the photon path unknown, but the path is in fact not yet determined. However, when a photon is physically detected along either the first or second paths, the detected path is determined with 100% certainty to be and, incredibly, also to have been all along, the actual path of the photon from the origin to the destination. Therefore, at this point the photon loses its wave-like properties and behaves like a particle whose path is determinable.

According to quantum theory, when a beam of photons having an undeterminable path impinges on a spectrometer screen, the photons behave as wave-like entities and, thus, an interference pattern appeals on the screen. In contrast, when a beam of photons having a determinable path impinges on the spectrometer screen, the photons behave as particle-like entities and, thus, no interference pattern appears on the screen.

Uncertainty also exists in other observable parameters of a fast moving particle. For example, the spin of a fast moving particle is not discernable until the particle spin is actually measured. This leads to many interesting phenomena that have been proven experimentally. For example, it is well known that a pair of photons may be generated simultaneously to propagate in different directions by a spontaneous event. Such “twin” photons are known to have diametrically opposite spins, e.g., if one photon is measured to be “spin up”, it can be determined with certainty that the other photon is “spin down”. However, as the two photons travel in different directions, before being measured, the two photons are described by a common wave equation, according to which their respective spins and locations are inherently uncertain. The meaning of this phenomenon is that, for example, the spin of a photon may be determined with certainty by an event that took place at an extremely remote location, possibly light years away.

It will be appreciated by persons skilled in the art that the above-described phenomena rely on well-known principles of quantum physics, and have all been proven experimentally decades ago.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a system for transmitting and receiving data using path state modulation in accordance with one exemplary embodiment of the invention;

FIG. 2 is a schematic illustration of a system for transmitting and receiving data using path state modulation in accordance with another exemplary embodiment of the invention;

FIG. 3 is a schematic illustration of a full-duplex two-way data communication system using path state modulation according to exemplary embodiments of the invention; and

FIG. 4 is a schematic illustration of a system for transmitting data by path state modulation in accordance with yet another exemplary embodiment of the invention.

It will be appreciated that for simplicity and clarity of illustration, elements shown in the figures have not necessarily been drawn accurately or to scale. For example, the dimensions of some of the elements may be exaggerated relative to other elements for clarity or several physical components included in one element. Further, where considered appropriate, reference numerals may be repeated among the figures to indicate corresponding or analogous elements. It will be appreciated that these figures present examples of embodiments of the present invention and are not intended to limit the scope of the invention.

### DESCRIPTION OF EXEMPLARY EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Although the conventional wisdom dictates that information cannot be transferred over a macroscopic distance without being carried by some form of matter or energy, as a carrier, and thus information cannot conventionally travel at a speed higher than the speed of light in vacuum, the inventors of this application have found no proof or evidence in any existing theories, including the Theory of Relativity and Quantum Theory, to explain why information per se, e.g., a sequence of data bits in their abstract form, cannot be transmitted by a medium other than mass or energy in the conventional sense. In fact, as described above, according to quantum theory, a physical property or state of a first particle-wave entity, at a first location in space, may be determined substantially instantaneously by an event affecting a second, correlated, particle-wave entity at a second location in space, regardless of the distance between the first and second locations. We believe that a person skilled in the art, upon reading this document, will appreciate that communication of information, in its pure abstract form, using path state modulation that does not rely on mass or energy as the carrier medium, across a macroscopic distance, is in fact possible and can be proven experimentally. Indeed, examples of such experiments are proposed below. Furthermore, some of the methods, systems and device of the present invention as proposed below may enable, in theory, transfer of substantive information at speeds higher than the speed of light, or even substantially instantaneously, across a macroscopic distance.

Exemplary embodiments of the present invention provide devices, methods and systems for transmission of information data from a first (“origin”) site to a second (“destination”) site, by modulating the possible paths of particle-wave entities, wherein the distance between the first site and the second site may be a macroscopic distance. The invention does not rely directly on any known form of energy, matter, or other tangible medium to carry the transmitted information between the first and second sites. Instead, the information data is modulated at the origin site by selectively alternating the possible paths of a stream of particle-wave entities, e.g., a stream of photons or fast-moving electrons, between a first (“certain”) state, in which the particle-wave entities behave as particles and thus have a determinable path, and a second (“uncertain”) state, in which the particle-wave entities behave as waves and thus have an undeterminable path. It will be appreciated by persons skilled in the art that the state of a particle-wave entity under conditions as described below is inherently binary, i.e., the state can be either certain or uncertain depending on the state of the possible paths of the particle. Based on this observation, the present inventors have suggested that informative binary data can be modulated into the system or wave-function that defines the particle-wave entities, e.g., by modulating the state of the particle-wave entities between their certain state (e.g., “1”) and their uncertain state (e.g., “0”).

At any point in time when the particle-wave entities are in their first, particle-like state, an intersection of their possible paths cannot form an interference pattern and, thus, an interference pattern is not observed at the destination site. In contrast, when the particle-wave entities are in the second, wave-like state, an interference pattern is formed, and may thus be observed, at the destination site. Therefore, an interferometer or any other interference observing device at the destination site is able to determine whether the possible beam paths are in the first state or in the second state.

In some embodiments, a first stream of particle-wave entities travels towards the destination site via a first set of possible paths, while a second stream of particle-wave entities travels simultaneously towards the origin site via a second set of possible paths. The two sets of paths may be correlated, e.g., one set “mirrors” the other, such that a certainty in the first set of possible paths is instantaneously correlated with a corresponding certainty in the second set of possible paths and, conversely, an uncertainty in the first set of possible paths is instantaneously correlated with a corresponding uncertainty in the second set of possible paths. In other words, the second set of possible paths may “mirror” the first set of possible paths. According to embodiments of the invention and quantum theory principles, modulation of the second set of possible paths between their first and second states results in a corresponding, simultaneous, modulation of the first set of possible paths between their first and second states. If the possible paths of the first set (i.e., traveling towards the destination site) and the possible paths of the second set (i.e., traveling towards the information origin site) are of comparable length, i.e., a substantially symmetrical system, then an observation of whether or not an interference pattern appears at the destination is correlated substantially simultaneously with the corresponding modulation performed at the modulation site, thereby substantially instantaneously demodulating the data modulated at the information origin site. Alternatively, if the possible paths of the first set of paths are delayed relative to the possible paths of the second set, the observation of whether or not an interference pattern appears at the destination may be delayed, but such delay might still correspond to a speed higher than the speed of light. The amount of delay of this configuration relative to the substantially instantaneous communication of the symmetrical configuration may depend on various system parameters, such as the relative lengths of the first possible paths and the second possible paths. It will be appreciated that for effective transmission of data using the methods described herein, in some embodiments of the invention it may be desired that the length of the first possible paths be equal to or greater than the length of the second possible paths.

In view of the above, if the first state of the possible paths is defined as “0” and the second state of the possible paths is defined as “1”, then a sequential readings of “yes” or “no” interference pattern at the destination site is correlated with the sequence of modulation between the first state and second state of the paths, respectively, as it is performed at the information origin site. This may result in real-time demodulation of the information data at the destination site as it is being modulated at the information origin site, e.g., by selectively switching the states of the paths at the information origin site between their certain and uncertain positions. In this manner, any information data, e.g., in the form of binary data bits, may be transmitted from the first site to the second site.

In some embodiments of the invention, the particle-wave entities being analyzed are photons. A photon stream may be generated by a coherent light source, e.g., a laser. The photon stream may pass through a beam splitter, which splits the previously certain photon path into first and second possible paths, which are uncertain. Hence, after passing the beam splitter, the path of a given photon is uncertain. When the photon encounters either a first down-converter (e.g., spontaneous parametric down-converter as is known in the art), positioned along the first possible path, or a second down-converter (e.g., spontaneous parametric down-converter as is known in the art), positioned along the second possible path, the encountered down-converter regenerates a pair of photons in different, e.g., opposite directions, for example, one photon may travel towards the destination site and the other photon may travel towards the information origin site. The regenerated photons may be substantially identical in their physical properties and may have the same energy, e.g., each regenerated photon may have half the energy of the original photon. Since the original photon stream is coherent, the regenerated photon streams are necessarily also coherent. The regeneration process produces this pair of photons with certainty; however, the regeneration event itself is contingent upon whether or not the possible path leading to the regenerating down-converter is the actual path of the original photon. Therefore, the uncertainty in the possible paths leading to the respective down-converters results in a corresponding uncertainty as to whether or not the regeneration event takes place at either the first or second down-converter, and so there is a corresponding uncertainty in the possible paths of the regenerated photons leading to the destination site and to the information origin site, respectively. In other words, there may be a set of two possible paths leading to the destination path and a set of two possible paths leading to the origin site, and the two sets of path are correlated. In this configuration, detection at the origin site of a regenerated photon on either the first or second path of either the first or second sets of paths would result In certainty of the path of the detected photon and, consequently, in certainty as to the identity of the down-converter by which the detected photon was regenerated. Interestingly, the path of the other regenerated photon, which may be near or at the destination site, becomes equally certain because this other regenerated photon was produced by the same down-converting event. Thus, by selectively detecting or not detecting, at will, the regenerated photon at the origin site, the state of the photon at the destination can be substantially instantaneously switched between its certain and uncertain states, respectively. If the modulation of the photon states at the origin site is performed according to a binary data sequence, the photon at the destination site may be switched between its certain and uncertain states in correlation with the modulation at the origin site. By intersecting the possible paths of the regenerated photons on a suitable interference-observing device, e.g., an interferometer screen, at the destination site, it is possible to determine the sequence of switching between the first and second states, for example, by recording on a time line the sequence at which an interference pattern appears and disappears at the interference-observing device.

As described in detail below, a modulator of the state of the possible photon paths at the origin site can be realized, for example, in the form of a switchable beam re-combiner or beam splitter at a point of intersection of the regenerated possible photon paths at the origin site. Switching of the functionality of the beam re-combiner or beam splitter at the origin site may be performed by one or more switchable detectors associated with the possible paths in the vicinity of beam re-combiner or beam splitter.

Except for the specific structures and functionality described below, with reference to exemplary embodiments of the invention and the accompanying drawings, it will be appreciated by persons skilled in the art that the principles of the invention, as well as specific structures and functionality of elements that are shown and described, can he understood in such a way as to enable a person of ordinary skill in the art to practice the invention without undue experimentation.

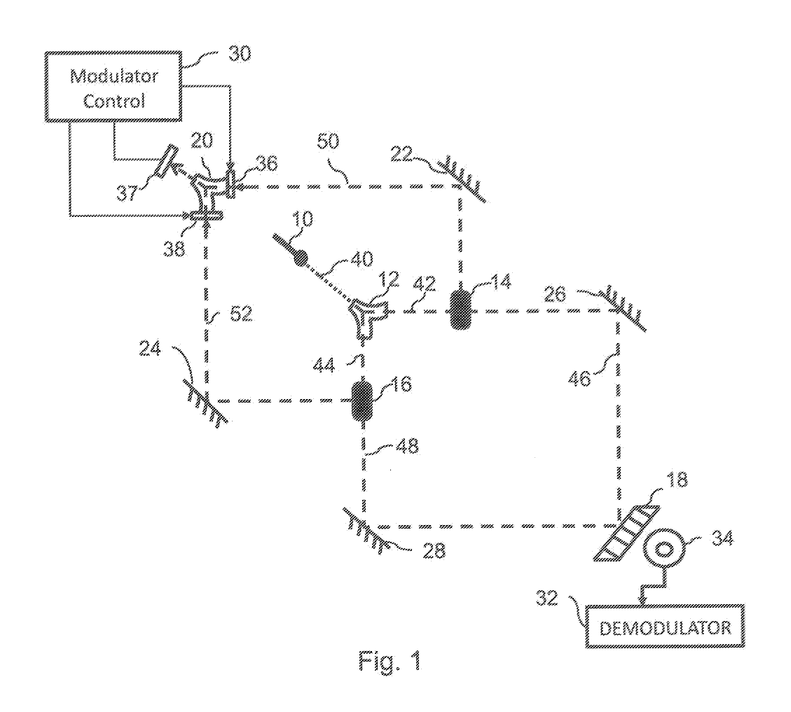

Reference is made to FIG. 1, which schematically illustrates a system for transmitting and receiving data by path state modulation in accordance with one exemplary embodiment of the invention. A coherent light source, e.g., a photon generator 10 may generate a coherent light beam including a stream of photons along path 40. A beam splitter 12, which may include any beam splitter as is known in the art, for example, a symmetric beam splitter, splits the stream of photons such that each photon has an inherently equal probability of traveling along either a possible path 42, which leads to a first down-converter 14, or a possible path 44, which leads to a second down-converter 16. As is known in the art, if and when a photon is received by first down-converter 14, a regeneration event occurs whereby two regenerated photons of equal energy, e.g., each having half the energy of the original photon, continue along separate paths, e.g., possible paths 46 and 50, respectively. Conversely, if and when a photon is received by second down-converter 16, a regeneration event occurs whereby two regenerated photons of equal energy, e.g., each having half the energy of the original photon, continue along separate paths, e.g., possible paths 48 and 52, respectively. It will be appreciated by persons skilled in the art that possible paths 46 and 48 “mirror”, i.e., are correlated with, possible paths 50 and 52, respectively, whereby the uncertainty as to which of possible paths 46 and 48 might be the path of a first photon of a pair of photons regenerated by either down-converter 14 or down-converter 16, is correlated with a corresponding uncertainty as to which of possible paths 50 and 52 might be the path of a second photon of the pair of photons regenerated by either down-converter 14 or down-converter 16.

In some embodiments of the invention, one or more optical element, which are substantially incapable of measuring or detecting at least some, preferably most, or all photons impinging thereon, may be placed at predetermined position along possible paths 46, 48, 50 and 52. For example, mirrors 26, 28, 22 and 24 are schematically shown on possible paths 46, 48, 50 and 52, respectively.

It will be appreciated by persons skilled in the art that a suitable optical configuration may be arranged to cause intersection of possible paths 46 and 48 at a predetermined position relative to an interference-measuring device, which may include, for example, an interferometer screen 18 and an interference sensor 34, as are known in the art, or any other suitable device or combination of devices. Sensor 34 may provide a signal, which may be a binary signal, responsive to whether or not an interference pattern appears on screen 18. A demodulator 32 may receive the signal provided by sensor 34. Demodulator 32 may demodulate the signal, e.g., by assigning a binary “1” value for each time window during which an interference pattern is sensed, and a binary “0” value for each time window during which no interference pattern is sensed. Based on this sequence of values, the demodulator is able to produce a digital signal corresponding to a modulation sequence produced by a path modulator associated with possible paths 50 and 52, e.g., at a distant site, where the information originates, as described in detail below. It will be appreciated by persons skilled in the art that the demodulation rate of demodulator 32 depends on the rate at which data may be modulated at the modulation site (described below), but the information transfer rate from the modulation site to the demodulation site may not add latency to the process, as in conventional systems, because each data may be modulated and demodulated substantially simultaneously, even though the modulation site and demodulation site may be far away from each other.

Another optical configuration, which may include one or more mirrors, such as mirrors 22 and 24, may be arranged to cause intersection of possible paths 50 and 52 in the vicinity of a path modulator 20, which may be located at an information origin site, e.g., far away from the demodulation site described above. In the embodiment of FIG. 1, path modulator 20 may include a beam combiner or re-combiner, as is known in the art, able to combine possible paths 50 and 52 into a single path, such that any and all photons that might enter combiner 20 from either path 50 or path 52, e.g., via respective input ports (as shown schematically in FIG. 1), must continue to travel along a single, combined, output path, which output path may lead to a photon-detector 37, as is known in the art, which may be an optional element of the system and may be used for explanatory purposes, as discussed below, or for monitoring the operation of the system.

In some embodiments of the invention, the combined light beam exiting combiner 20 are perfectly aligned, such that there is no way to distinguish the origin of either beam. Furthermore, in some embodiments, the beams in the combined beam exiting combiner 20 may be aligned across a very long distance, e.g., a significant percentage of the distance of communication between the information origin site and the information destination site. It will be appreciated by persons skilled in the art that a long section of substantially perfect alignment of the combined beams may be helpful in achieving higher observablilty of the appearing and disappearing interference pattern being observed by the demodulator. This is because a longer alignment distance results in a more significant distinguishing component between in the wave equations of the combined photons being observed relative to the wave equations of the non-combined photons being observed.

The two input ports of beam combiner 20 may include switchable detectors 36 and 38, associated with possible paths 50 and 52, respectively. Switchable detectors 36 and 38 may include, for example, any device able to selectively detect, absorb, admit or block photons attempting to enter combiner 20 from possible paths 50 and 52, respectively. The selective control of detectors 36 and 38 may be performed in response to a control input, e.g., a voltage signal, provided by a modulator controller 30. In this manner, combiner 20 may function as a path modulator and is able to selectively modulate the quantum state of paths 50 and 52 between their “certain” and “uncertain” states, according to the principles described in detail above. Accordingly, when switchable detectors 36 and 38 are in a non-detection mode, possible paths 50 and 52 are combined and a photon en route to the modulation site may be detected by optional photon-detector 37 (if used). In this mode, possible paths 50 and 52 cannot be traced and are, thus, in an “uncertain” state. This results in the appearance of an interference pattern on interferometer 18, which is located at the demodulation site, according to the principles described above. However, when switchable detectors 36 and 38 are in a detection mode, a photon en route to the modulation site is detected by one of the switchable detectors and thus possible paths 50 and 52 are not combined. In this mode, paths 50 and 52 can be traced with certainty and are, thus, in a “certain” state. This results in disappearance of the interference pattern on interferometer 18, according to the principles described above, at the demodulation site.

Thus, by selectively switching the mode of operation of switchable detectors 36 and 38 between their detection and no-detection modes, information in the form of digital data bits may be modulated at predetermined time intervals (“windows”), which may depend on the switching rate of available switching devices and/or on the minimal time required to allow a sufficient number of photons to reach interferometer 18 with conclusive evidence of whether or not an interference pattern is being formed. The modulation of possible paths as described above may be preformed in accordance with digital data input to modulation controller 30, which data may represent the information to be transmitted by the system to the demodulation site.

Detector 37, which may or may not be used for the system to operate, may be used to confirm the flow of photons out of beam combiner 20. However, according to the principles of quantum theory, actual measurement by detector 37 may not affect the state of certainty or uncertainty of possible paths 50 and 52.

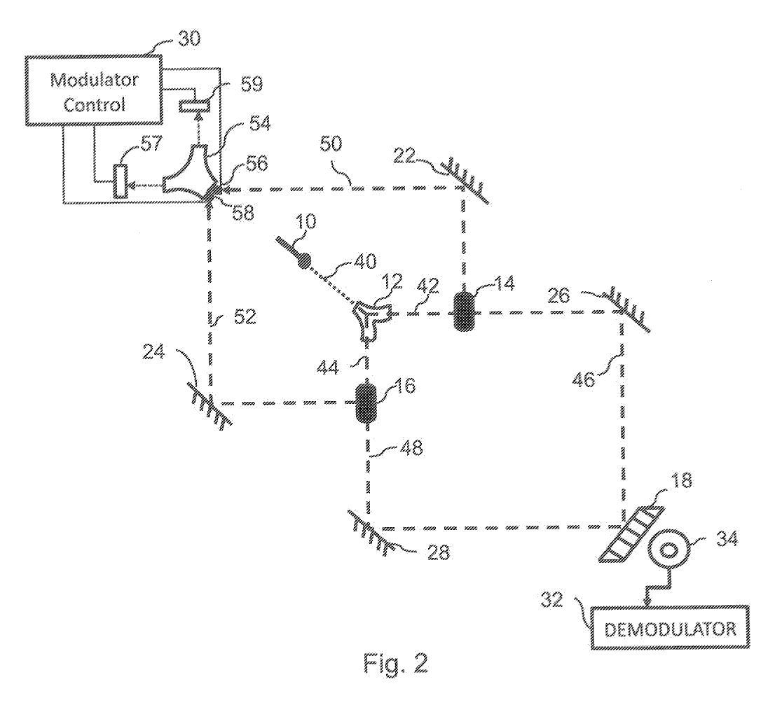

Reference is now made to FIG. 2, which schematically illustrates a system for transmitting and receiving data by path state modulation in accordance with another exemplary embodiment of the invention. It will be appreciated by persons skilled in the art that, except as described below, the operation of the system in FIG. 2 may be generally identical to the operation of the system of FIG. 1, and that identically numbered elements may have generally the same structure and functionality in both embodiments.

In the embodiment of FIG. 2, the path modulator may include a beam splitter 54, for example a symmetric beam splitter, as is known in the art, instead the beam combiner described above with reference to FIG. 1. In analogy to the description of the original beam splitter 12 above, beam splitter 54 is able to split incoming possible paths 50 and 52 into two new possible path, such that an incoming photon arriving from either possible path 50 or possible path 52 has an inherently equal probability to exit beam splitter 54 either in the direction leading to a photon-detector 57 or in the direction leading to photon-detector 59, as is known in the art. As with detector 37 of FIG. 1, detectors 57 and 59 may be optional elements of the system and may be used for explanatory purposes, as discussed below, or for monitoring the operation of the system. In contrast to the embodiment of FIG. 1, in this embodiment, there are two possible paths exiting beam splitter 54. However, since these exit paths are not correlated with the possible input paths 50 and 52, i.e., the exit paths are random, beam splitter 54 causes uncertainty in possible paths 50 and 52, as further discussed below.

An input region of beam splitter 54 may include switchable detectors 56 and 58, associated with possible paths 50 and 52, respectively. Switchable detectors 56 and 58 may include, for example, any device able to selectively detect, absorb, admit or block photons attempting to enter beam splitter 54 from possible paths 50 and 52, respectively. The selective control of switchable detectors 56 and 58, which may be simultaneous, may be performed in response the control input, e.g., a voltage signal, provided by modulator controller 30, as discussed above. In this manner, combiner 54 may function as a path modulator and is able to selectively modulate the quantum state of paths 50 and 52 between their “certain” and “uncertain” states, according to the principles described in detail above. Accordingly, when detectors 56 and 58 are in a non-detection mode, possible paths cannot be traced back to their source and, thus, paths 50 and 52 are in an “uncertain” state. This results in the appearance of an interference pattern on interferometer 18, which is located at the demodulation site, according to the principles described above. However, when detectors 56 and 58 are in a detection mode, a photon en route to the modulation site is detected by one of the switchable detectors and thus possible paths 50 and 52 can be traced to their source with certainty and are, thus, in a “certain” state. This results in disappearance of the interference pattern on interferometer 18, according to the principles described above, at the demodulation site.

Thus, by selectively switching the mode of operation of switchable detectors 56 and 58 between their detection and no-detection mode, information in the form of digital data bits may be modulated at predetermined time intervals (“windows”), as discussed above. The modulation of possible paths may be preformed in accordance with digital data input to modulation controller 30, which data may represent the information to be transmitted by the system to the demodulation site.

Detectors 57 and 59, which may or may not be used for the system to operate, may be used to confirm the flow of photons out of beam splitter 54. However, according to the principles of quantum theory, actual measurement by detectors 57 and 59 may not affect the state of certainty or uncertainty of possible paths 50 and 52.

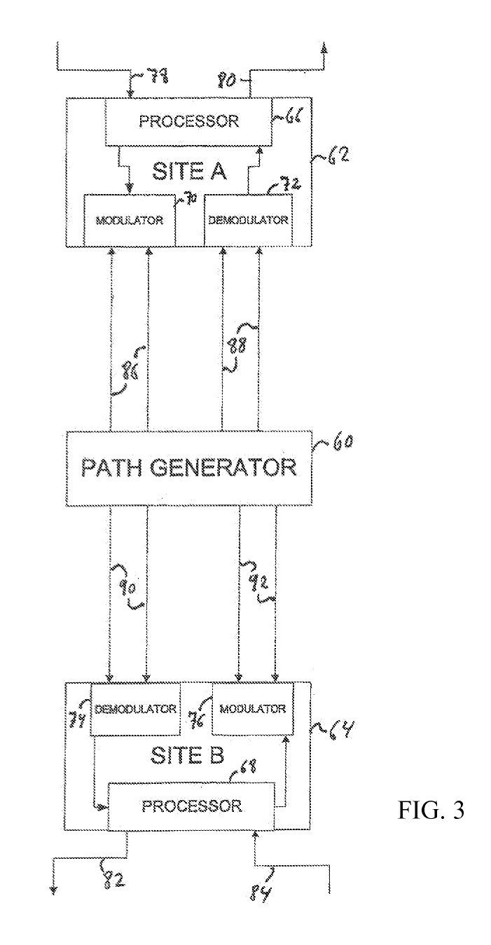

Reference is now made to FIG. 3, which schematically illustrates a system for two-way data communication using path state modulation according to exemplary embodiments of the invention. The system of FIG. 3 includes a path generator 60 to generate possible paths for photons traveling towards a first site, denoted “Site A”, and a second site, denoted “Site B”. Possible paths 86 define possible paths leading to a modulator 70 at Site A; possible paths 88 define possible paths leading to a demodulator 72 at Site A; possible paths 90 define possible paths leading to a demodulator 74 at Site B; and possible paths 92 define possible paths leading to a modulator 76 at Site B. Paths 86 and 90 are associated with a first source of coherent light in path generator 60, whereas paths 88 and 92 are associated with a second source of coherent light in path generator 60. The first and second coherent light sources may be independent of each other and may include, for example, any coherent light source, e.g., a laser source, as described above with reference to FIGS. 1 and 2. The structural configuration defining paths 86, 88, 90 and 92 may be generally similar to the configurations described above with reference to FIGS. 1 and 2 and may include, for example, first and second beam splitters, which may be similar to the beam splitter 12 described above, associated with the first and second coherent light sources, respectively.

The structural configuration defining paths 86 and 90 may include two down-converters similar to down-converters 14 and 16 in FIGS. 1 and 2, as well as optical elements, in analogy to mirrors 22, 24, 26 and 28 in FIGS. 1 and 2, to geometrically define paths 86 and 90. In this manner, modulator 70 may modulate informative data bits at Site A to be demodulated by demodulator 74 at Site B, according to principles of the invention. Thus, path-modulated transmission of data from Site A to Site B is enabled. A processor 66 at Site A may receive input data 78 and provide an input to modulator 70 representing data to be transmitted to Site B. A processor 68 at Site B may receive the data as it is being demodulated by demodulator 74 and may produce a desired output 82 to be used for various functionalities at site B.

The structural configuration defining paths 88 and 92 may also include two down-converters similar to down-converters 14 and 16 in FIGS. 1 and 2, as well as optical elements to geometrically define paths 88 and 92. In this manner, modulator 76 may modulate informative data bits at Site B to be demodulated by demodulator 72 at Site A, according to principles of the invention. Thus, path-modulated transmission of data from Site B to Site A is enabled. Processor 68 at Site B may receive input data 84 and provide an input to modulator 76 representing data to be transmitted to Site A. Processor 66 at Site A may receive the data as it is being demodulated by demodulator 72 and may produce a desired output 80 to be used for various functionalities at site A.

In some embodiments of the invention, sites A and B may be far away, for example, on different planets or even in different galaxies. Path generator 60 may be located, in principle, anywhere between Site A and Site B. However, to achieve substantially simultaneous communication between Site A and Site B, e.g., to achieve substantially instantaneous transmission and reception at both sites, a person skilled in the art will appreciate that it may be desirable to position path generator 60 at a substantially equal distance from both Site A and Site B. Nevertheless, in certain applications of the invention, one-way communication may be sufficient and, therefore, it may be possible to position path generator 60 closer to either Site A or Site B, depending on which site is the transmitter and which side is the receiver, and keeping in mind that such one-way communication may not be instantaneous (although theoretically it may still be considerably faster than the speed of light).

In some embodiments of the invention, Site A may be located on a first spaceship traveling in space at a first known speed, V, for example, 30,000 kilometers per hour, and may travel continually from planet Earth outwards into the vastness of the universe. In this embodiment, path generator 60 may be located on a second spaceship traveling at a second known speed, U, for example 15,000 kilometers per hour. Site B may be located on planet Earth or at any other desired location of reference. In this manner, hyper-light-speed communication may be maintained continually between Site A on the first spaceship and Site B at the reference point as the first spaceship travels endlessly into the universe. If V=2U, then two-way communication is possible and, more importantly, communication between the first spaceship and the reference point may be substantially instantaneous regardless of the distance traveled by the two spaceships. This embodiment of the invention may be used to continually provide at the reference point substantially instantaneous, i.e., real time, images produced by a digital camera mounted on the first spaceship.

It will be appreciated that the exemplary system of FIG. 3 is a full duplex two-way communication system. Other embodiments of the invention may be implemented in the form of a two-way, interleaved transmission, data communication system, wherein the same communication paths may be used intermittently, during predefined time slots, to either transmit from Site A and receive at Site B, or transmit from Site B and receive at Site A. This may be achieved by installing both a modulator and a demodulator on the beam paths at each of the two sites, and switching between the modulator and demodulator functions of each site according to an interleaved bi-directional communication scheme.

It an interleaved system according to some embodiments of the invention, instead of using only a path state modulator at an origin site and only a path state demodulator at a destination state, a symmetric system design may be implemented to perform the functions of both the path state modulator and the path state demodulator at either site, as described below, whereby each site functions intermittently as both an information origin site and an information destination site, thus enabling two-way, interleaved, communication between the two sites, e.g., according to a predefined time-sharing protocol. In this embodiment, beam combiners (or beam splitters) may be used as path state modulators of a Site A and Site B, respectively. During modulation at either site, the operation of each of the two modulators may be generally similar to the operation of modulator 20 in FIG. 1 and/or modulator 54 in FIG. 2.

In the interleaved communication embodiment, each of the path modulators may include a beam combiner or re-combiner, as is known in the art, able to combine possible paths 50 and 52 into a single path, as described above with reference to combiner 20 in FIG. 1. It will be appreciated by persons skilled in the art that a symmetric, two-way, communication device may also be implemented using beam splitters as shown in FIG. 2 rather than beam combiners, and that such devices are also within the scope of the present invention. In contrast to the one-way communication system of FIGS. 1 and 2 above, in the interleaved two-way communication embodiment the output paths of the two beam combiners, both of which are spatially “certain”, as discussed above, may lead to respective interferometers at Sites A and B. Each of the two interferometer may detect whether or not an interference pattern appears within a predefined time slot assigned to either Site A reception or Site B reception. A predefined interleaved communication scheme may include a sequence of intermittent periods of reception at Sites A and B, such that site A may demodulate information data as it is being modulated at Site B, and Site B may demodulate information data as it is being modulated at Site A.

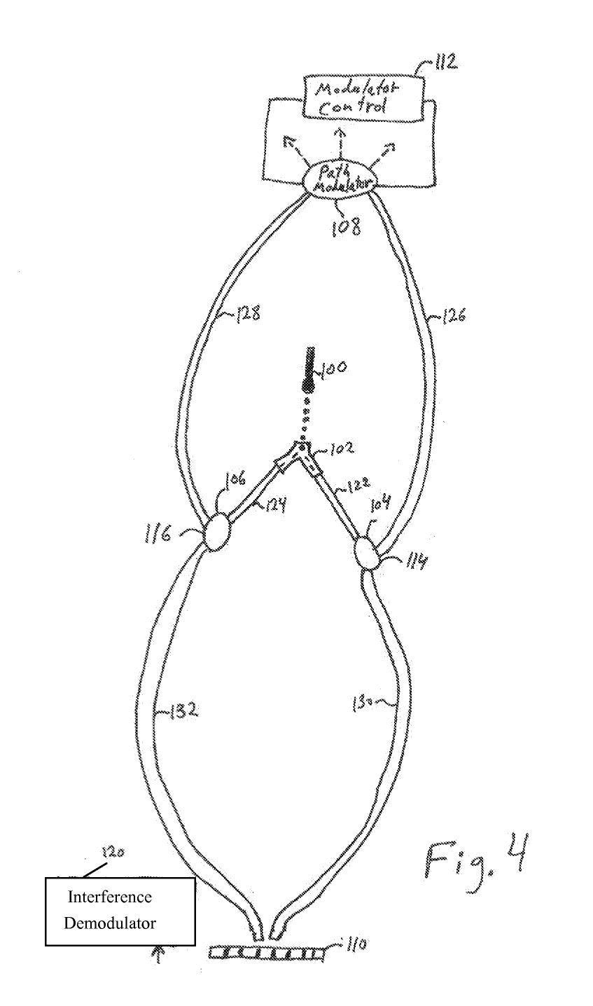

Reference is now made to FIG. 4, which is a schematic illustration of a system for transmitting and receiving data by path sate modulation in accordance with yet another exemplary embodiment of the invention. The structures, functions and principles of operation of the system of FIG. 4 may be generally the same as those described above with reference to the embodiments of FIG. 1, FIG. 2 and/or FIG. 3. However, a notable distinction of the system in FIG. 4 is the use of optical fibers, for example, coherent optical fibers or any other type of optical fibers as are known in the art that will not cause significant undesired detection of photons along the possible photon paths. By using fiber optics to connect the different elements of the path-modulated communication system, the embodiment of FIG. 4 may be significantly more versatile than the systems of FIGS. 1 and 2 in its potential uses. For example, the system may be integrated into an optical fiber system, possibly into some existing optical fiber systems, to provide substantially instantaneous, or nearly instantaneous, communication across any reasonable distance on earth or on other planets or moons that may be inhabited in the future. Various types of fiber-optical networks may be formed based on the principles of the present invention, e.g., by assembling a global communication network of possible photon paths according to the principles of the present invention.

The system of FIG. 4 includes a coherent (e.g., laser) light source 100 and a beam splitter 102, which may be similar to those described in previous embodiments. Beam splitter 102 may he connected to a pair of down-converters 104, 106, via optical fibers 122, 124, respectively. A first set of output ports at respective output configurations 114 and 116 of down-converters 104 and 106, respectively, where one of each pair of regenerated photons may be directed, as described above, may be connected via optical fibers 126 and 128 to a path modulator 108, e.g., a path modulator as described above with reference to FIGS. 1 and 2. The operation of path modulator 108 may be controlled, as described above, by a modulation controller 112. Thus, optical fibers 126 and 128 may be used to define the possible paths on the modulation side of the system. A second set of output ports at respective output configurations 114 and 116 of down-converters 104 and 106, respectively, where the other of each pair of regenerated photons may be directed, may lead, via optical fibers 130 and 132, to an interferometer 110, e.g., such as those described above with reference to FIGS. 1 and 2. A pattern sensor 118, e.g., as is known in the art, may sense the data-carrying sequence of appearing and disappearing interference patterns on interferometer 110 and may produce a signal responsive to the sequence of patterns. An interference demodulator 120 may receive and analyze the signal produced by sensor 118 and may provide a corresponding digital signal carrying the information being demodulated. This information may be transferred to additional components for further processing, e.g., as is known in the art.

It will be appreciated by persons skilled in the art that all the embodiments of the embodiments of the invention described above may have the important advantage of enabling strictly secured, point-to-point (“P2P”), communication between connected parties. The reason for this advantage lies in the fact that information is not being physically carried by any form of matter or energy; rather, the information may be transmitted substantially instantaneously by modulation of possible paths of particle-wave entities at the origin site, and demodulation the information by observing a sequence of appearance and disappearance of interference patterns being formed at the destination site. Therefore, a potential eavesdropper will not be able to discern any useful information by tapping the physical links defining the possible paths of the particle-wave entities, simply because no useful information is carried by the particle-wave entities.

Furthermore, it will be appreciated by persons skilled in the art that, although no matter or energy can be transferred instantaneously to remote locations based on the principles of the present invention, virtual entities, for example, computer software able to perform desired functions may be transferred without bounds to any location where the system may evolve to reach, even deep into space. Such virtual entities may possess human-like features and characteristics, e.g., artificial intelligence, and may be used to explore the universe further.

While the invention has been described with respect to a limited number of embodiments, it will be appreciated that many variations, modifications and other applications of the invention may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes as fall within the true spirit of the invention.

What is claimed is:

1. A communication method comprising:
modulating one more information data bits at a first site by selectively switching the path state of a first stream of photons; and
demodulating said information data bits at a second site by detecting appearance and disappearance of an interference pattern of a second stream of photons correlated with said first stream of photons.

2. A communication system comprising:
a path-state modulator to modulate one more information data bits by selectively switching the path state of a first stream of photons at a first site; and
a path-state demodulator to demodulate said information data bits by detecting at a second site appearance and disappearance of an interference pattern of a second stream of photons correlated with said first stream of photons.
